(19) United States
(12) Patent Application Publication
(10) Pub. No.: US 2026/0342398 A1
(43) Pub. Date: Oct. 29, 2026

(54) LINEAR COMBINATION COEFFICIENT ENCODING FOR CHANNEL STATE INFORMATION REPORTING IN MULTI-TRANSMISSION RECEPTION POINT COHERENT JOINT TRANSMISSION

(71) Applicant: Apple Inc., Cupertino, CA (US)

(72) Inventors: Haitong Sun, San Jose, CA (US); Ismael Gutierrez Gonzalez, San Jose, CA (US); David Neumann, Munchen, Bavaria-Bayern (DE); Dawei Zhang, Saratoga, CA (US); Wei Zeng, Saratoga, CA (US); Weidong Yang, San Diego, CA (US); Ghaith N Hattab, Santa Clara, CA (US); Louay Jalloul, Santa Clara, CA (US)

(21) Appl. No.: 19/121,462

(22) PCT Filed: Oct. 10, 2023
(86) PCT No.: PCT/US2023/034775

§ 371 Date: Apr. 16, 2025

Related U.S. Application Data
(60) Provisional application No. 63/422,737, filed on Nov. 4, 2022.

(51) Int. Cl. H04B 7/06

(52) U.S. Cl. CPC H04B 7/0626

(57) ABSTRACT

Apparatus, processors, and methods are provided for channel state information (CSI) reporting for coherent joint transmission using multiple transmission reception points (TRPs). In one example, a baseband processor of a user equipment (UE), is configured to, based on channel state information (CSI) measurement resources transmitted by a plurality of transmission reception points (TRPs), determine a plurality of non-zero coefficients (NZCs) corresponding to linear combination coefficients. The baseband processor selects reported NZCs from the plurality of NZCs, wherein respective sets of reported NZCs are associated with respective transmission layers, wherein at least one of the sets of reported NZCs includes NZCs associated with at least two different TRPs. The baseband processor is configured to generate a CSI report that encodes, for each transmission layer, information about the reported NZCs and transmit the CSI report.

### CROSS-REFERENCE TO RELATED APPLICATIONS

This application claims the benefit of priority from U.S. Provisional Patent Application Ser. No. 63/422,737, entitled LINEAR COMBINATION COEFFICIENT ENCODING FOR CHANNEL STATE INFORMATION REPORTING IN MULTI-TRANSMISSION RECEPTION POINT COHERENT JOINT TRANSMISSION, filed on Nov. 4, 2022, the contents of which are incorporated herein by reference in their entirety.

### BACKGROUND

Multi-transmission reception point (TRP) communication involves a user equipment (UE) exchanging signals with more than one TRP. The multiple TRPs may be integrated into a same base station or different base stations. A UE may communicate with different TRPs using different beams. The data transmitted and received between the UE and the multiple TRPs may be jointly processed to improve reliability, coverage, and capacity performance through flexible deployment scenarios. In multi-TRP coherent joint transmission, a single transmission layer includes transmissions from multiple TRPs.

### BRIEF DESCRIPTION OF THE DRAWINGS

Some examples of circuits, apparatuses and/or methods will be described in the following by way of example only. In this context, reference will be made to the accompanying figures.

FIG. 1A illustrates a UE receiving channel state information (CSI) measurement resources from multiple TRPs and transmitting a CSI report based on measurements of the CSI measurement resources, in accordance with various aspects described.

FIG. 1B illustrates a UE receiving a coherent joint transmission of physical downlink shared channel (PDSCH) from multiple TRPs, in accordance with various aspects described.

FIG. 2 illustrates an example codebook for a transmission layer, in accordance with various aspects described.

FIG. 3 illustrates an example linear combination coefficient matrix for a given TRP, including eight spatial bases, four frequency bases and two polarities, in accordance with various aspects described.

FIG. 4 illustrates an example message sequence including communication of a CSI report and PDSCH using multi-TRP coherent joint transmission, in accordance with various aspects described.

FIG. 5 is a diagram of an example network according to one or more implementations described herein.

FIG. 6 illustrates a simplified block diagram of a user equipment wireless communication device, in accordance with various aspects described.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

### Multi-TRP Coherent Joint Transmission

Multiple input, multiple output (MIMO) communication systems utilize joint transmission in which transmit signals from multiple antennas are jointly processed at a receiving device. A set of signals that are jointly processed at the receiving device is referred to as a transmission layer. Each signal in the transmission layer is referred to as a spatial stream. Each spatial stream corresponds to a set of precoder settings applied to a particular antenna/polarity combination, or spatial basis.

There are two types of joint transmission, non-coherent joint transmission (NCJT) and coherent joint transmission (CJT). In CJT, the network performs beamforming with multiple transmission points and selects beamforming coefficients (phase and amplitude) for the spatial streams transmitted by each antenna so that, together, the spatial streams focus the transmission energy at the UE. In order to support CJT, the network uses knowledge about the downlink channels for each antenna, or may use the same downlink channel information when the antennas are co-located. In NCJT the network does not coordinate the spatial streams from the different antennas to focus energy at the UE and the spatial streams are received independently by the UE.

Previous releases of the 3GPP specification support NCJT for multi-TRP use cases, however the standard does not currently support non-transparent CJT for multi-TRP use cases. Due to the detailed channel information needed to support CJT in multi-TRP use cases, existing channel state information (CSI) reporting should be extended to allow for reporting of CSI for several (e.g., up to four) different TRPs, which may not be co-located.

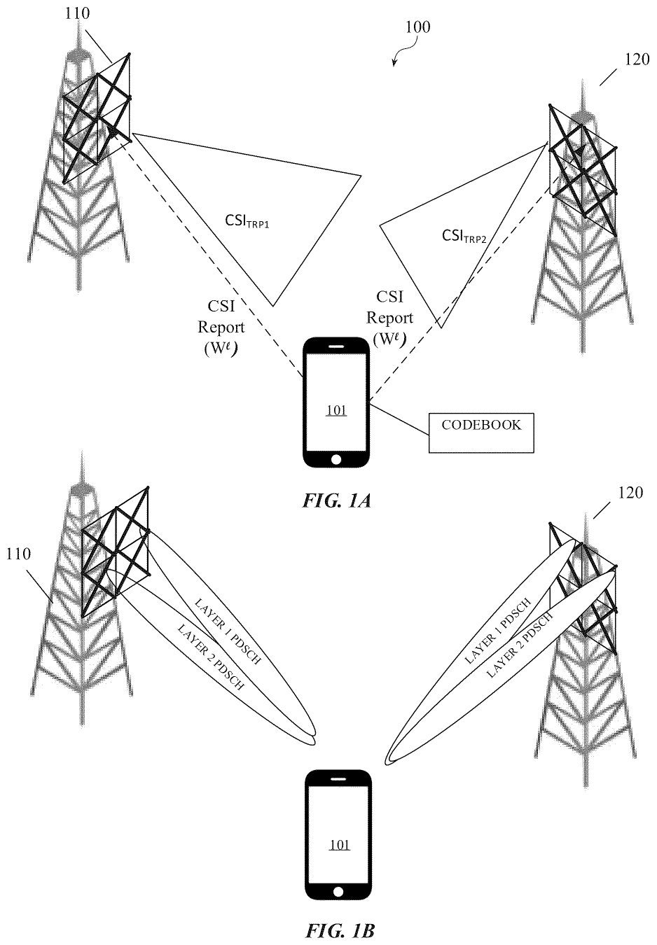

Referring now to FIGS. 1A and 1B, a wireless communication network 100 is illustrated that includes UE 101 and two TRPs 110, 120. Multi-TRP CJT is used to transmit a physical downlink shared channel (PDSCH) in two transmission layers from the TRPs 110, 120 to the UE 101. The TRPs are illustrated as being located on different base stations, however, in other examples, the TRPs may be mounted on a same base station or on other structures. Each TRP is illustrated as having eight antenna elements, four antenna elements having horizontal polarity and four antenna elements having vertical polarity (each pair of elements with opposite polarities are illustrated by the bold Xs in FIGS. 1A and 1B. Thus, in the illustrated network there are 2×8 or 16 spatial bases (8 spatial bases for each TRP). In the illustrated example, the UE has two receiving antennas and thus two transmission layers may be used for CJT. The number of transmission layers may be signaled via a rank indicator (RI) value.

As shown in FIG. 1A, the UE 101 has been pre-configured with a codebook (e.g., a type II MIMO codebook) that defines indices used by the UE to indicate, in a CSI report, which beamforming coefficients should be used by the TRP for each transmission layer. Each TRP 110, 120 transmits CSI measurement resources (e.g., CSI-RS), which are received and measured by the UE to determine the best beams and corresponding beamforming coefficients for downlink CJT. Indices of the coefficients are reported by the UE in the CSI report per the codebook. As illustrated in FIG. 1B, the TRPs set their corresponding beamforming coefficients to transmit the PDSCH in transmission layer 1 and transmission layer 2 to the UE.

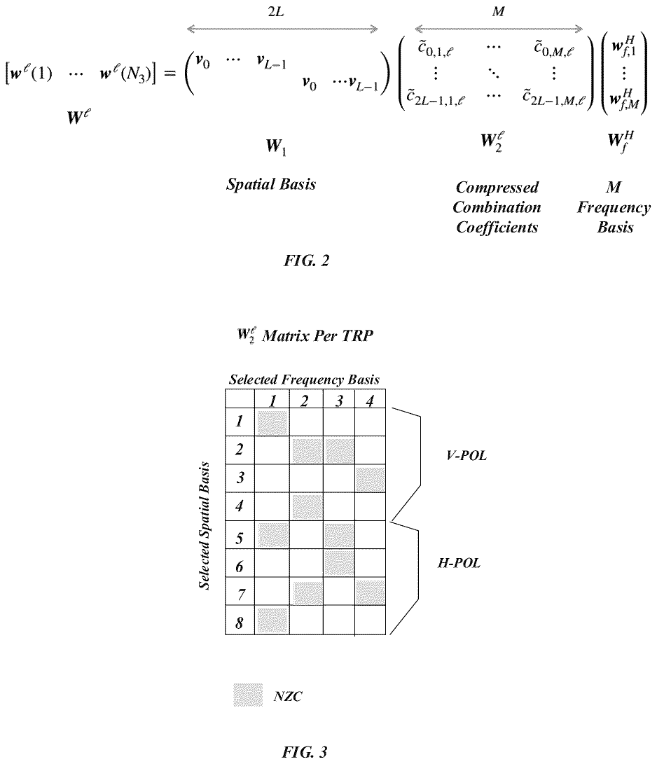

The CSI report includes a precoder matrix indicator (PMI) component that encodes the spatial bases, the frequency bases, and the corresponding coefficients selected by the UE. FIG. 2 illustrates one example of a codebook (W^{l}) that encodes the precoding information for a transmission layer l using three matrices. A W₁ matrix indicates which of the spatial bases are selected subject to a network configured maximum per transmission layer (e.g., 8 in some examples). A

$${W}_{f}^{H}$$

matrix indicates which of several configured frequency bases are selected for each spatial basis. A

$${W}_{2}^{l}$$

matrix for each transmission layer is included in the codebook and corresponds to a compressed matrix specifying linear combination coefficients that are to be applied to the selected spatial bases indicated in the W₁ matrix and the frequency bases indicated in the

$${W}_{f}^{H}$$

matrix. When multi-TRP CJT is used, there may be two different type II codebook structures. A first codebook structure allows for different linear combination coefficients to be specified for different TRPs, while in another codebook structure it is assumed that the same linear combination coefficients are used for all the TRPs. Different techniques for encoding the W₂ matrix for transmission in a CSI report are disclosed herein.

FIG. 3 illustrates an example W₂ matrix for a single transmission layer for a single TRP. Each row in the matrix corresponds to one of the spatial bases selected by the W₁ matrix and each column corresponds to one of the frequency bases selected by the

$${W}_{f}^{H}$$

matrix. Each cell in the W₂ matrix represents a coefficient having an amplitude quantization and phase quantization that would be applied to the spatial basis and frequency basis. In some configurations, the spatial bases are selected such that half of the spatial bases are of one polarity and half of the spatial bases are of the other polarity. Further, the spatial bases may be selected such that pairs of spatial bases corresponding to a same antenna with a first spatial basis in the pair having a first polarity and the second spatial basis in the pair having a second polarity. A general case is illustrated in FIG. 3 in which the spatial bases are not so constrained.

Each shaded cell indicates a non-zero linear combination coefficient (hereinafter non-zero coefficient or NZC) for a downlink beam of sufficient strength sensed by the UE whilst the unshaded cells correspond to coefficients that correspond to downlink beams that were not detected or did not meet a threshold strength. The W₂ matrix is encoded in the CSI report by first identifying locations of the NZCs in the matrix and then indicating, for each NZC, the corresponding amplitude quantization and phase quantization. The number of NZCs that are included in the CSI report may be limited by the network. Thus, all of the NZCs for the beams detected by the UE as shown in the W₂ matrix of FIG. 3 may not be reported. Certain of the NZCs will be selected by the UE for inclusion in the CSI report and these NZCs are referred to herein as reported NZCs.

In multi-TRP CJT, for each transmission layer there is a W₂ matrix for each TRP. As the number of transmission layers and TRPs increases, the number of reported NZCs that are to be encoded in the CSI report increases. The construction of the CSI report should feature efficient encoding of the location, phase quantization, and amplitude quantization of the W₂ matrix to conserve signaling overhead.

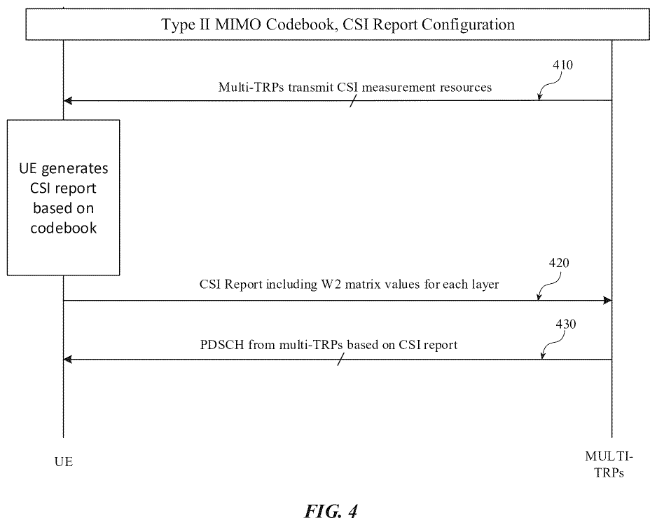

FIG. 4 is a message flow diagram outlining multi-TRP CJT. The UE is preconfigured with a type II MIMO codebook and a CSI report configuration that specifies parameters for the quantities to be reported, the format of the report, and so on. At 410, the TRPs transmit CSI measurement resources. The UE measures the measurement resources, selects preferred beams and ranks the beams based on strength, and generates the CSI report based on the codebook to report information about the preferred beams including the W₁, W₂ (one matrix for each transmission layer and TRP), W₃ matrices. At 420 the UE transmits the CSI report to at least one of the TRPs or another node that is coordinating the multi-TRP CJT. At 430 the multiple TRPs transmit a PDSCH in one or more transmission layers according to the codebook reported by the UE in the CSI.

Several techniques for encoding the reported NZC locations, as well as indications of the phase quantization information and amplitude quantization information for each reported NZC in the CSI report will now be disclosed. Depending on use cases, the different disclosed approaches may be optionally configured or dynamically indicated.

### Location and Number of Reported NZCs

There are several approaches to encoding NZC locations. The locations of the reported NZCs may be independently encoded on a per transmission layer basis (meaning that the NZC locations may be different for different transmission layers), a per transmission layer and polarization and TRP basis (meaning that the NZC locations may be different for each unique combination of transmission layer/polarization/TRP), or a per TRP basis (meaning that the NZC locations may be different for different TRPs), or a per transmission layer and TRP basis (meaning that the NZC locations may be different for each unique combination of transmission layer/TRP). The locations of the reported NZCs may be commonly encoded on a per transmission layer basis (meaning that the NZC locations are the same for all transmission layers), a per transmission layer and polarization and TRP basis (meaning that the NZC locations are the same for each unique combination of transmission layer/polarization/TRP), or a per TRP basis (meaning that the NZC locations are the same across all TRPs).

There are several approaches to configuring a maximum number of reported NZCs. In one example, the network can configure a maximum number of reported NZCs per transmission layer, K_{NZC}, without an upper limit on a total number of reported NZCs. In another example, the network can configure a maximum number of reported NZCs per transmission layer (K_{NZC}) and a transmission layer threshold. In this case the maximum total number of reported NZCs is calculated as the transmission layer threshold multiplied by K_{NZC}. For example, if the transmission layer threshold is 2, then the number of reported NZCs for any transmission layer cannot exceed K_{NZC}, and the total number reported NZCs across all transmission layers cannot exceed 2·K_{NZC}. In other examples, the network can configure a maximum number of reported NZCs per transmission layer per polarization or per transmission layer per TRP, or any other combination of transmission layer, frequency, polarization, and/or TRP.

In one example, the UE may be configured to select a number of reported NZCs that is equal to the configured maximum number of reported NZCs. In another example, the UE may be enabled to select a number of reported NZCs that is less than or equal to the configured maximum number of reported NZCs and report the number of reported NZCs in the CSI report (e.g., in CSI part 1 or CSI part 2).

### Reporting Groups

To efficiently encode the indication of the phase quantization and amplitude quantization for each reported NZC, the reported NZCs may be grouped into one or more multiple groups, with each group including a reference NZC. Different reporting groups may be used for phase quantization reporting and amplitude quantization reporting. In the following description the multiple groups are indicated as {w₂}_{g}, g=1, 2, . . . , G. G is the number of groups and {w₂}_{g} represents all the NZC in group g. Within each group one NZC is selected as the reference NZC, denoted as

$${( {w}_{2}^{*} )}_{g} .$$

The remaining NZCs in the group are denoted as

$${\{ {w}_{2} \}}_{g} \text{\textbackslash (} {{w}_{2}^{*} )}_{g}$$

where \ is the set subtraction operation indicating all the NZCs in {w₂}_{g} excluding

$${( {w}_{2}^{*} )}_{g} .$$

The reported NZCs may be divided into reporting groups based on different criteria. In one example, the reported NZCs are grouped into a different reporting group for each transmission layer, regardless of polarization. In another example, the reported NZCs may be grouped into a single reporting group that includes all the reported NZCs. In another example, the reported NZCs are grouped into a different reporting group for each polarization. In another example, the reported NZCs are grouped into a different reporting group on a per transmission layer and per polarization basis.

In another example, the reported NZCs are grouped into a different groups on a per transmission layer per TRP basis or a per transmission layer per TRP group basis. In this example, all the reported NZCs associated with the same TRP or TRP group in the same transmission layer are in the same reporting group regardless of polarization. Each TRP or TRP group may be represented by one CSI-RS (e.g., channel measurement resource).

In another example, the reported NZCs are grouped into a different groups on a per transmission layer per TRP per polarization basis or a per transmission layer per TRP group per polarization basis. In this example, all the reported NZCs associated with the same TRP or TRP group in the same transmission layer are separated into reporting groups based on polarization. Each TRP or TRP group may be represented by one CSI-RS (e.g., channel measurement resource).

### Phase Encoding

In one example, for phase encoding, among all of the reference,

$$NZCs {( {w}_{2}^{*} )}_{g} ,$$

g=1, 2, . . . , G, one reference NZC is identified as a primary reference

$$NZCs {w}_{2}^{*} .$$

The phase of

$${w}_{2}^{*}$$

is assumed to be zero and is not reported. In one example, the other reference

$$NZCs ( {( {w}_{2}^{*} )}_{g} ∖ {w}_{2}^{*} )$$

are phase quantified and reported based on the phase difference between the phase of the corresponding NZC and the phase of the reference NZC. In another example, the other reference

$$NZCs ( {( {w}_{2}^{*} )}_{g} ∖ {w}_{2}^{*} )$$

quantization value is not included in the CSI report which indicates a zero value).

In one example, the phase quantization of the remaining NZCs (e.g., non-reference NZCs) are differentially encoded with respect to the reference NZC for their respective group g

$${( {w}_{2}^{*} )}_{g} .$$

In one example, the phase quantization of the remaining NZCs (e.g., non-reference NZCs) are differentially encoded with respect to the primary reference

$$NZC {w}_{2}^{*} .$$

In one example, the phase quantization of each reference

$$NZC {( {w}_{2}^{*} )}_{g}$$

is encoded using a larger number of bits (e.g., 4 bits) whilst the phase quantization of the remaining NZCs

$$( i . e . , {\{ {w}_{2} \}}_{g} ∖ {( {w}_{2}^{*} )}_{g} )$$

are each encoded using a smaller number of bits (e.g., 3 bits).

### Amplitude Encoding

In one example, for amplitude encoding, among all of the reference

$$NZCs {( {w}_{2}^{*} )}_{g} ,$$

g=1, 2, . . . , G, one reference NZC is identified as a primary reference

$$NZC {w}_{2}^{*} .$$

The amplitude of

$${w}_{2}^{*}$$

is assumed to be one and is not report. In one example, the other reference

$$NZCs ( {( {w}_{2}^{*} )}_{g} ∖ {w}_{2}^{*} )$$

are amplitude quantified and reported based on a ratio between the amplitude of the corresponding NZC and the amplitude of the reference NZC. In another example, the other reference

$$NZCs ( {( {w}_{2}^{*} )}_{g} ∖ {w}_{2}^{*} )$$

are assumed to have amplitude of one and are not reported (e.g., a amplitude quantization value is not included in the CSI report which indicates a value of one).

In one example, the amplitude quantization of the remaining NZCs (e.g., non-reference NZCs) are differentially encoded with respect to the reference NZC for their respective group g

$${( {w}_{2}^{*} )}_{g} .$$

In one example, the amplitude quantization of the remaining NZCs (e.g., non-reference NZCs) are differentially encoded with respect to the primary reference

$$NZC {w}_{2}^{*} .$$

In one example, the amplitude quantization of each reference

$$NZC {( {w}_{2}^{*} )}_{g}$$

is encoded using a larger number of bits (e.g., 4 bits) whilst the amplitude quantization of the remaining

$$NZCs ( i . e . , {\{ {w}_{2} \}}_{g} ∖ {( {w}_{2}^{*} )}_{g} )$$

are each encoded using a smaller number of bits (e.g., 3 bits).

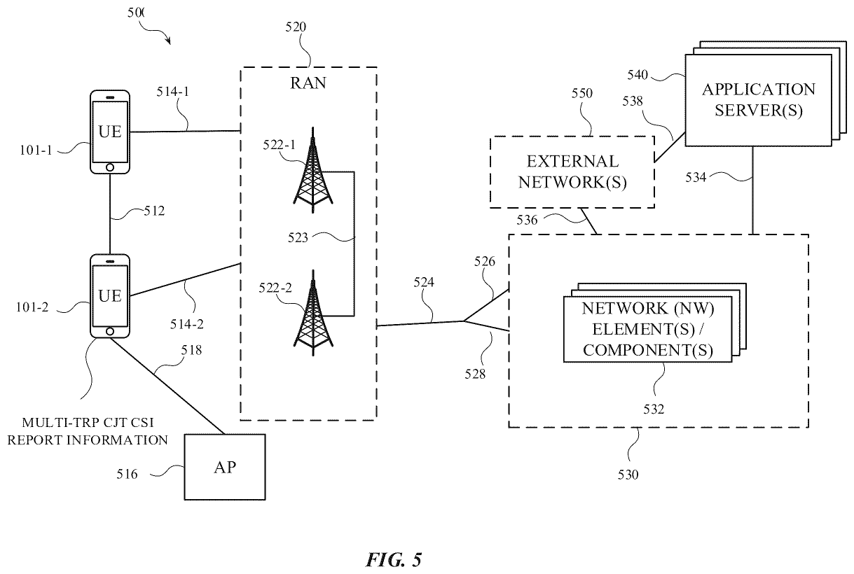

FIG. 5 is an example network 500 according to one or more implementations described herein. Example network 500 may include UEs 101-1, 101-2, etc. (referred to collectively as “UEs 101” and individually as “UE 101”), a radio access network (RAN) 520, a core network (CN) 530, application servers 540, and external networks 550.

The systems and devices of example network 500 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 500 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 101 may include smartphones (e.g., handheld touchscreen mobile computing devices connectable to one or more wireless communication networks). Additionally, or alternatively, UEs 101 may include other types of mobile or non-mobile computing devices capable of wireless communications, such as personal data assistants (PDAs), pagers, laptop computers, desktop computers, wireless handsets, etc. In some implementations, UEs 101 may include internet of things (IoT) devices (or IoT UEs) that may comprise a network access layer designed for low-power IoT applications utilizing short-lived UE connections.

UEs 101 may communicate and establish a connection with (e.g., be communicatively coupled) with RAN 520, which may involve one or more wireless channels 514-1 and 514-2, each of which may comprise a physical communications interface/layer.

As described herein, a UE 101-2 may operate in multi-TRP mode in which the UE is simultaneously communicating with multiple transmission reception points (TRPs) (e.g., a TRP associated with network node 522-1 and a TRP associated with network node 522-2) in multi-TRP CJT. The UE 101-2 is configured to receive, store, and process multi-TRP CJT CSI report information that causes the UE 101-2 to perform functions described above with respect to encoding a CSI report for multi-TRP CJT. The multi-TRP CJT CSI report information may include instructions or algorithms used by the UE for determining how to encode determined linear combination coefficients according to a MIMO type II codebook for within a CSI report.

As shown, UE 101 may also, or alternatively, connect to access point (AP) 516 via connection interface 518, which may include an air interface enabling UE 101 to communicatively couple with AP 516. AP 516 may comprise a wireless local area network (WLAN), WLAN node, WLAN termination point, etc. The connection to AP 516 may comprise a local wireless connection, such as a connection consistent with any IEEE 702.11 protocol, and AP 516 may comprise a wireless fidelity (Wi-Fi®) router or other AP. While not explicitly depicted in FIG. 5, AP 516 may be connected to another network (e.g., the Internet) without connecting to RAN 520 or CN 530.

RAN 520 may include one or more RAN nodes 522-1 and 522-2 (referred to collectively as RAN nodes 522, and individually as RAN node 522) that enable channels 514-1 and 514-2 to be established between UEs 101 and RAN 520. RAN nodes 522 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 522 may include a roadside unit (RSU), a transmission reception point (TRxP or TRP), and one or more other types of ground. In some scenarios, RAN node 522 may be a dedicated physical device, such as a macrocell base station, and/or a low power (LP) base station for providing femtocells, picocells or the like having smaller coverage areas, smaller user capacity, or higher bandwidth compared to macrocells.

The PDSCH may carry user data and higher layers signaling to UEs 101. The physical downlink control channel (PDCCH) may carry information about the transport format and resource allocations related to the PDSCH channel, among other things. The PDCCH may also inform UEs 101 about the transport format, resource allocation, and hybrid automatic repeat request (HARQ) information related to the uplink shared channel. Typically, downlink scheduling (e.g., assigning control and shared channel resource blocks to UE 101-2 within a cell) may be performed at any of the RAN nodes 522 based on channel quality information fed back from any of UEs 101 based on the multi-TRP CJT CSI report information. The downlink resource assignment information may be sent on the PDCCH used for (e.g., assigned to) each of UEs 101.

The RAN nodes 522 may be configured to communicate with one another via interface 523. In implementations where the system is an LTE system, interface 523 may be an X2 interface. In NR systems, interface 523 may be an Xn interface. The X2 interface may be defined between two or more RAN nodes 522 (e.g., two or more eNBs/gNBs or a combination thereof) that connect to evolved packet core (EPC) or CN 530, or between two eNBs connecting to an EPC.

As shown, RAN 520 may be connected (e.g., communicatively coupled) to CN 530. CN 530 may comprise a plurality of network elements 532, which are configured to offer various data and telecommunications services to customers/subscribers (e.g., users of UEs 101) who are connected to the CN 530 via the RAN 520. In some implementations, CN 530 may include an evolved packet core (EPC), a 5G CN, and/or one or more additional or alternative types of CNs.

As shown, CN 530, application servers 540, and external networks 550 may be connected to one another via interfaces 534, 536, and 538, which may include IP network interfaces. Application servers 540 may include one or more server devices or network elements (e.g., virtual network functions (VNFs) offering applications that use IP bearer resources with CN 530 (e.g., universal mobile telecommunications system packet services (UMTS PS) domain, LTE PS data services, etc.). Application servers 540 may also, or alternatively, be configured to support one or more communication services (e.g., voice over IP (VOIP sessions, push-to-talk (PTT) sessions, group communication sessions, social networking services, etc.) for UEs 101 via the CN 530. Similarly, external networks 550 may include one or more of a variety of networks, including the Internet, thereby providing the mobile communication network and UEs 101 of the network access to a variety of additional services, information, interconnectivity, and other network features.

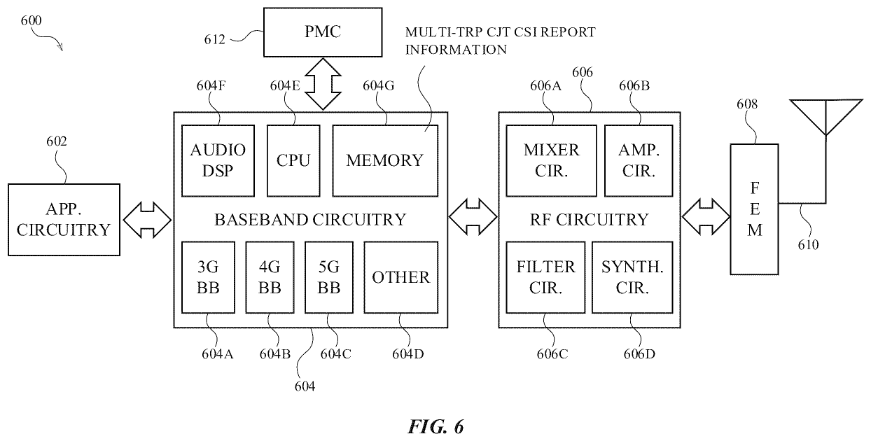

FIG. 6 is a diagram of an example of components of a device or apparatus of a UE according to one or more implementations described herein. In some implementations, the apparatus 600 can include application circuitry 602, baseband circuitry 604, RF circuitry 606, front-end module (FEM) circuitry 608, one or more antennas 610, and power management circuitry (PMC) 612 coupled together at least as shown. The components of the illustrated apparatus 600 can be included in a UE (101 of FIG. 1) or a RAN node (e.g., TRPs 110, 120 of FIG. 1). In some implementations, the apparatus 600 can include fewer elements (e.g., a RAN node may not utilize application circuitry 602, and instead include a processor/controller to process IP data received from a CN or an Evolved Packet Core (EPC)).

The application circuitry 602 can include one or more application processors. For example, the application circuitry 602 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the UE. In some implementations, processors of application circuitry 602 can process IP data packets received from an EPC.

The baseband circuitry 604 can include circuitry such as, but not limited to, one or more single-core or multi-core processors. The baseband circuitry 604 can include one or more baseband processors or control logic to process baseband signals received from a receive signal path of the RF circuitry 606 and to generate baseband signals for a transmit signal path of the RF circuitry 606. Baseband circuitry 604 can interface with the application circuitry 602 for generation and processing of the baseband signals and for controlling operations of the RF circuitry 606. For example, in some implementations, the baseband circuitry 604 can include a 3G baseband processor 604A, a 4G baseband processor 604B, a 5G baseband processor 604C, or other baseband processor(s) 604D for other existing generations, generations in development or to be developed in the future (e.g., 5G, 6G, etc.). The baseband circuitry 604 (e.g., one or more of baseband processors 604A-D) can handle various radio control functions that enable communication with one or more radio networks via the RF circuitry 606. In other implementations, some or all of the functionality of baseband processors 604A-D can be included in modules stored in the memory 604G and executed via a Central Processing Unit (CPU) 604E.

In some implementations, memory 604G may store and process multi-TRP CJT CSI report information that causes the UE to perform functions described above with respect to common beam management for multi-TRP operation. The multi-TRP CJT CSI report information may cause the UE 101 to perform functions described above with respect to encoding a CSI report for multi-TRP CJT. The multi-TRP CJT CSI report information may include instructions, that when executed by a BB processor 604C or CPU 604E, cause a UE to encode determined linear combination coefficients according to a MIMO type II codebook for within a CSI report.

In some implementations, the baseband circuitry 604 can include one or more audio digital signal processor(s) (DSP) 604F. The audio DSPs 604F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 604 and the application circuitry 602 can be implemented together such as, for example, on a system on a chip (SOC).

In some implementations, the baseband circuitry 604 can provide for communication compatible with one or more radio technologies. For example, in some implementations, the baseband circuitry 604 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 604 is configured to support radio communications of more than one wireless protocol can be referred to as multi-mode baseband circuitry.

RF circuitry 606 can enable communication with wireless networks using modulated electromagnetic radiation through a non-solid medium. In various implementations, the RF circuitry 606 can include switches, filters, amplifiers, etc. to facilitate the communication with the wireless network. RF circuitry 606 can include a receive signal path which can include circuitry to down-convert RF signals received from the FEM circuitry 608 and provide baseband signals to the baseband circuitry 604. RF circuitry 606 can also include a transmit signal path which can include circuitry to up-convert baseband signals provided by the baseband circuitry 604 and provide RF output signals to the FEM circuitry 608 for transmission.

In some implementations, the receive signal path of the RF circuitry 606 can include mixer circuitry 606A, amplifier circuitry 606B and filter circuitry 606C. In some implementations, the transmit signal path of the RF circuitry 606 can include filter circuitry 606C and mixer circuitry 606A. RF circuitry 606 can also include synthesizer circuitry 606D for synthesizing a frequency for use by the mixer circuitry 606A of the receive signal path and the transmit signal path.

While FIG. 6 shows the PMC 612 coupled only with the baseband circuitry 604. However, in other implementations, the PMC 612 may be additionally or alternatively coupled with, and perform similar power management operations for, other components such as, but not limited to, application circuitry 602, RF circuitry 606, or FEM circuitry 608.

Processors of the application circuitry 602 and processors of the baseband circuitry 604 can be used to execute elements of one or more instances of a protocol stack. For example, processors of the baseband circuitry 604, alone or in combination, can be used execute Layer 3, Layer 2, or Layer 1 functionality, while processors of the baseband circuitry 604 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a baseband processor of a user equipment (UE), configured to based on channel state information (CSI) measurement resources transmitted by a plurality of transmission reception points (TRPs), determine a plurality of non-zero coefficients (NZCs) corresponding to linear combination coefficients; select reported NZCs from the plurality of NZCs, wherein respective sets of reported NZCs are associated with respective transmission layers, wherein at least one of the sets of reported NZCs includes NZCs associated with at least two different TRPs; generate a CSI report that encodes, for each transmission layer, information about the reported NZCs; and transmit the CSI report.

Example 2 includes the subject matter of example 1, including or omitting optional elements, wherein the CSI report independently encodes locations of NZPs within a preconfigured matrix on a per transmission layer basis, a per transmission layer and polarization and TRP basis, or a per TRP basis.

Example 3 includes the subject matter of example 1, including or omitting optional elements, wherein the CSI report commonly encodes locations of NZPs within a preconfigured matrix on a per transmission layer basis, a per transmission layer and polarization and TRP basis, or per TRP basis.

Example 4 includes the subject matter of example 1, including or omitting optional elements, further configured to determine the reported NZCs based on a network-configured maximum number of NZCs per transmission layer.

Example 5 includes the subject matter of example 4, including or omitting optional elements, wherein the network-configured maximum number of NZCs per layer is independent of a number of transmission layers.

Example 6 includes the subject matter of example 4, including or omitting optional elements, further configured to determine the reported NZCs based on a network-configured maximum total number of NZCs across all transmission layers.

Example 7 includes the subject matter of example 6, including or omitting optional elements, wherein the maximum total number of NZCs is based on a preconfigured threshold number of selected transmission layers, such that the maximum total number of NZCs is based on the product of the maximum number of NZCs per transmission layer and the threshold number.

Example 8 includes the subject matter of example 1, including or omitting optional elements, further configured to determine the reported NZCs based on network-configured maximum numbers of NZCs per transmission layer and polarization or per transmission layer and TRP.

Example 9 includes the subject matter of example 1, including or omitting optional elements, further configured to select a number of reported NZPs that is less than or equal to a network-configured maximum number of NZCs; and indicate the selected number of reported NZCs in the CSI report.

Example 10 includes the subject matter of example 1, including or omitting optional elements, further configured to select a number of reported NZPs that is equal to a network-configured maximum number of NZCs.

Example 11 includes the subject matter of example 1, including or omitting optional elements, further configured to group the reported NZCs into a plurality of reporting groups, wherein each reporting group includes a reference NZC and zero or more remaining NZCs; and encode an indication of phase quantization or an indication of amplitude quantization for the reported NZCs based on the reporting groups.

Example 12 includes the subject matter of example 11, including or omitting optional elements, further configured to group the reported NZCs into reporting groups on a per transmission layer basis.

Example 13 includes the subject matter of example 11, including or omitting optional elements, further configured to group the reported NZCs into a single reporting group.

Example 14 includes the subject matter of example 11, including or omitting optional elements, further configured to group the reported NZCs into reporting groups on a per transmission layer and TRP basis or a per transmission layer and TRP group basis.

Example 15 includes the subject matter of example 11, including or omitting optional elements, further configured to group the reported NZCs into reporting groups on a per transmission layer and TRP and polarization basis.

Example 16 includes the subject matter of example 11, including or omitting optional elements, further configured to group the reported NZCs into reporting groups on a per polarization basis.

Example 17 includes the subject matter of example 11, including or omitting optional elements, further configured to group the reported NZCs into reporting groups on a per transmission layer and per polarization basis.

Example 18 includes the subject matter of example 11, including or omitting optional elements, further configured to, for the remaining NZCs in a reporting group, encode the indication of phase quantization based on a phase differential between the remaining NZC and the reference NZC for the group.

Example 19 includes the subject matter of example 11, including or omitting optional elements, wherein the indication of phase quantization for the reference NZCs does not encode phase quantization information indicating a value of zero.

Example 20 includes the subject matter of example 11, including or omitting optional elements, further configured to select one of the reference NZCs as a primary reference NZC; and for each the remaining NZCs in all the reporting groups, encode the indication of phase quantization based on a phase differential between the NZC and the primary reference NZC.

Example 21 includes the subject matter of example 11, including or omitting optional elements, further configured to, for the other reference NZCs, encode the indication of phase quantization based on a phase differential between the reference NZC and the primary reference NZC.

Example 22 includes the subject matter of example 20, including or omitting optional elements, wherein the indication of phase quantization indicates a phase quantization value of zero for the primary reference NZC by not encoding phase quantization information for the primary reference NZC.

Example 23 includes the subject matter of example 22, including or omitting optional elements, wherein the indication of phase quantization indicates a phase quantization value of zero for the reference NZCs by not encoding phase quantization information for the reference NZCs.

Example 24 includes the subject matter of example 11, including or omitting optional elements, further configured to quantize phase of the reference NZCs using more bits than a number of bits used to quantize the remaining NZCs.

Example 25 includes the subject matter of example 11, including or omitting optional elements, further configured to, for the remaining NZCs in a reporting group, encode the indication of amplitude quantization based on an amplitude differential between the remaining NZC and the reference NZC for the group.

Example 26 includes the subject matter of example 11, including or omitting optional elements, wherein the indication of amplitude quantization for the reference NZCs does not encode amplitude quantization information indicating a value of one.

Example 27 includes the subject matter of example 11, including or omitting optional elements, further configured to select one of the reference NZCs as a primary reference NZC; and for each the remaining NZCs in all the reporting groups, encode the indication of amplitude quantization based on an amplitude differential between the NZC and the primary reference NZC.

Example 28 includes the subject matter of example 27, including or omitting optional elements, further configured to, for the other reference NZCs, encode the indication of amplitude quantization based on a amplitude differential between the reference NZC and the primary reference NZC.

Example 29 includes the subject matter of example 27, including or omitting optional elements, wherein the indication of amplitude quantization indicates an amplitude quantization value of one for the primary reference NZC by not encoding amplitude quantization information for the primary reference NZC.

Example 30 includes the subject matter of example 29, including or omitting optional elements, wherein the indication of amplitude quantization indicates a amplitude quantization value of one for the reference NZCs by not encoding amplitude quantization information for the reference NZCs.

Example 31 includes the subject matter of example 11, including or omitting optional elements, further configured to quantize amplitude of the reference NZCs using more bits than a number of bits used to quantize the remaining NZCs.

Example 32 is a method that includes any action or combination of actions as substantially described herein in the Detailed Description.

Example 33 is a method as substantially described herein with reference to each or any combination of the Figures included herein or with reference to each or any combination of paragraphs in the Detailed Description.

Example 45 is a user equipment configured to perform any action or combination of actions as substantially described herein in the Detailed Description as included in the user equipment.

Example 35 is a network node configured to perform any action or combination of actions as substantially described herein in the Detailed Description as included in the network node.

Example 36 is a non-transitory computer-readable medium that stores instructions that, when executed, cause the performance of any action or combination of actions as substantially described herein in the Detailed Description.

Example 37 is an apparatus for a user equipment including a memory and one or processors that execute instructions stored in the memory cause the UE to perform of any action or combination of actions as substantially described herein in the Detailed Description.

Example 38 is an apparatus for a network node one or processors that execute instructions stored in the memory cause the network node to perform of any action or combination of actions as substantially described herein in the Detailed Description.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A user equipment (UE), comprising a memory and a baseband processor, the baseband processor configured to, when executing instructions stored in the memory:
based on channel state information (CSI) signals transmitted by a plurality of transmission reception points (TRPs), determine a plurality of non-zero coefficients (NZCs);
select reported NZCs from the plurality of NZCs, wherein respective sets of reported NZCs are associated with respective transmission layers, wherein at least one of the sets of reported NZCs includes NZCs associated with at least two different TRPs; and
transmit a CSI report that encodes, for each transmission layer, information about the reported NZCs.

2. The UE of claim 1, wherein the CSI report independently encodes locations of NZPs within a preconfigured matrix on a per transmission layer basis, a per transmission layer and polarization and TRP basis, or a per TRP basis.

3. The UE of claim 1, wherein the baseband processor is further configured to determine the reported NZCs based on a network-configured maximum number of NZCs per transmission layer.

4. The UE of claim 3, wherein the baseband processor is further configured to determine the reported NZCs based on a network-configured maximum total number of NZCs across all transmission layers.

5. The UE of claim 4, wherein the maximum total number of NZCs is based on a preconfigured threshold number of selected transmission layers, such that the maximum total number of NZCs is based on the product of the maximum number of NZCs per transmission layer and the threshold number.

6. The UE of claim 1, wherein the baseband processor is further configured to
select a number of reported NZPs that is less than or equal to a network-configured maximum number of NZCs; and
indicate the selected number of reported NZCs in the CSI report.

7. The UE of claim 1, wherein the baseband processor is further configured to
group the reported NZCs into one reporting group, wherein the reporting group includes a reference NZC and zero or more remaining NZCs; and
encode an indication of phase quantization or an indication of amplitude quantization for the reported NZCs based on the reporting group.

8. A baseband processor configured to, when executing instructions stored in a memory, perform operations, the operations comprising:
determining a plurality of non-zero coefficients (NZCs) based on channel state information (CSI) signals transmitted by a plurality of transmission reception points (TRPs);
selecting reported NZCs from the plurality of NZCs, wherein respective sets of reported NZCs are associated with respective transmission layers, wherein at least one of the sets of reported NZCs includes NZCs associated with at least two different TRPs; and
transmitting a CSI report that encodes, for each transmission layer, information about the reported NZCs.

9. The baseband processor of claim 8, wherein the CSI report independently encodes locations of NZPs within a preconfigured matrix on a per transmission layer basis, a per transmission layer and polarization and TRP basis, or a per TRP basis.

10. The baseband processor of claim 8, further comprising selecting the reported NZCs based on a network-configured maximum number of NZCs per transmission layer.

11. The baseband processor of claim 10, further comprising selecting the reported NZCs based on a network-configured maximum total number of NZCs across all transmission layers.

12. The baseband processor of claim 11, wherein the maximum total number of NZCs is based on a preconfigured threshold number of selected transmission layers, such that the maximum total number of NZCs is based on the product of the maximum number of NZCs per transmission layer and the threshold number.

13. The baseband processor of claim 8, further comprising
selecting a number of reported NZPs that is less than or equal to a network-configured maximum number of NZCs; and
indicating the selected number of reported NZCs in the CSI report.

14. The baseband processor of claim 13, further comprising
grouping the reported NZCs into one reporting group, wherein the reporting group includes a reference NZC and zero or more remaining NZCs; and
encoding an indication of phase quantization or an indication of amplitude quantization for the reported NZCs based on the reporting group.

15. A processor configured to, when executing instructions stored in a memory, cause a network node to:
receive a CSI report that encodes information about reported non-zero coefficients (NZCs), wherein respective NZCs are based on respective CSI signals transmitted by a plurality of transmission reception points (TRPs), wherein the CSI signals include CSI signals transmitted by the network node; and
wherein, in the CSI report, respective sets of reported NZCs are associated with respective transmission layers, wherein at least one of the sets of reported NZCs includes NZCs associated with at least two different TRPs.

16. The processor of claim 15, wherein the CSI report independently encodes locations of NZPs within a preconfigured matrix on a per transmission layer basis, a per transmission layer and polarization and TRP basis, or a per TRP basis.

17. The processor of claim 15, wherein a number of reported NZCs is based on a network-configured maximum number of NZCs per transmission layer.

18. The processor of claim 15, wherein a number of reported NZCs is based on a network-configured maximum total number of NZCs across all transmission layers.

19. The processor of claim 18, wherein the maximum total number of NZCs is based on a preconfigured threshold number of selected transmission layers, such that the maximum total number of NZCs is based on the product of the maximum number of NZCs per transmission layer and the threshold number.

20. (canceled)

21. The processor of claim 15, wherein
the CSI report groups the reported NZCs into one reporting group, wherein the reporting group includes a reference NZC and zero or more remaining NZCs; and
the CSI report encodes an indication of phase quantization or an indication of amplitude quantization for the reported NZCs based on the reporting group.
